(19) United States
(12) Patent Application Publication
(10) Pub. No.: US 2012/0137248 A1
(43) Pub. Date: May 31, 2012

(54) METHODS, SYSTEMS, AND COMPUTER PROGRAM PRODUCTS FOR AUTOMATICALLY SCROLLING ITEMS IN A SELECTION CONTROL

(76) Inventor: Robert Paul Morris, Raleigh, NC (US)

(21) Appl. No.: 12/955,993

(22) Filed: Nov. 30, 2010

(51) Int. Cl. G06F 3/048

(52) U.S. Cl. 715/784

(57) ABSTRACT

Methods and systems are described for automatically scrolling items in a selection control. A first portion of a plurality of items is presented in a selection control in a user interface via an output device. A second portion, of the plurality, is automatically presented subsequent to the presenting of the first portion. The second portion includes an item not included in the first portion. First selection information is received in response to a user input. The first selection information identifies a first selected item included in at least one of the first portion and the second portion. The first selected item is identified to a first operation handler configured to perform an operation based on the first selected item.

### BACKGROUND

Graphical user interfaces (GUIs) have changed the way users interact with electronic devices. In particular, GUIs have made performing commands or operations on records, files, and other data objects much easier. For example, users can use point-and-click interfaces to open documents, a delete key to delete a file, and a right click to access other commands. To operate on multiple data objects, such as files in a file folder, a user can press a <ctrl> key or a <shift> key while clicking on multiple files via a mouse or other pointing device to create a selection of more than one file. The user can then operate on all of the selected files via a context menu activated by, for example, a right-click; can “drag and drop” with a pointing device to copy, move, or delete the files; and can press a delete key to delete the files.

Prior to GUIs a user had to know the names of numerous operations and had to know how to use matching expressions including wildcard characters to perform an operation on a group of data objects.

Despite the fact that electronic devices have made many user tasks easier to perform, performing operations on multiple items remains a task requiring users to repeatedly provide input to locate and select objects and/or operations. This not only can be tedious for some users, it can lead to health problems as reported incidences of repetitive motion disorders indicate. Press-and-hold operations are particularly unhealthy when repeated often over extended periods of time. Operating on multiple objects presented on a graphical user interface remains user-input intensive and repetitive.

Accordingly, there exists a need for methods, systems, and computer program products for automatically scrolling items in a selection control.

### SUMMARY

The following presents a simplified summary of the disclosure in order to provide a basic understanding to the reader. This summary is not an extensive overview of the disclosure, and it does not identify key/critical elements of the invention or delineate the scope of the invention. Its sole purpose is to present some concepts disclosed herein in a simplified form as a prelude to the more detailed description that is presented later.

Methods and systems are described for automatically scrolling items in a selection control. In one aspect, the method includes presenting, in a selection control in a user interface via an output device, a first portion of a plurality of items. The method further includes, presenting, automatically and subsequent to the presenting of the first portion, a second portion, of the plurality, including an item not included in the first portion. The method still further includes receiving first selection information, in response to a user input, identifying a first selected item included in at least one of the first portion and the second portion. The method additionally includes identifying the first selected item to a first operation handler configured to perform an operation based on the first selected item.

Further, a system for automatically scrolling items in a selection control is described. The system includes an item handler component, an item resource component, a selection handler component, and a selection director component adapted for operation in an execution environment. The system includes the item handler component configured for presenting, in a selection control in a user interface via an output device, a first portion of a plurality of items. The system further includes the item resource component configured for, presenting, automatically and subsequent to the presenting of the first portion, a second portion, of the plurality, including an item not included in the first portion. The system still further includes the selection handler component configured for receiving first selection information, in response to a user input, identifying a first selected item included in at least one of the first portion and the second portion. The system additionally includes the selection director component configured for identifying the first selected item to a first operation handler configured to perform an operation based on the first selected item.

### BRIEF DESCRIPTION OF THE DRAWINGS

Objects and advantages of the present invention will become apparent to those skilled in the art upon reading this description in conjunction with the accompanying drawings, in which like reference numerals have been used to designate like or analogous elements, and in which:

FIG. 1 is a block diagram illustrating an exemplary hardware device included in and/or otherwise providing an execution environment in which the subject matter may be implemented;

FIG. 2 is a flow diagram illustrating a method for automatically scrolling items in a selection control according to an aspect of the subject matter described herein;

FIG. 3 is a block diagram illustrating an arrangement of components for automatically scrolling items in a selection control according to another aspect of the subject matter described herein;

FIG. 4a is a block diagram illustrating an arrangement of components for automatically scrolling items in a selection control according to another aspect of the subject matter described herein;

FIG. 4b is a block diagram illustrating an arrangement of components for automatically scrolling items in a selection control according to another aspect of the subject matter described herein;

FIG. 4c is a block diagram illustrating an arrangement of components for automatically scrolling items in a selection control according to another aspect of the subject matter described herein;

FIG. 4d is a block diagram illustrating an arrangement of components for automatically scrolling items in a selection control according to another aspect of the subject matter described herein;

FIG. 5 is a network diagram illustrating an exemplary system for automatically scrolling items in a selection control according to another aspect of the subject matter described herein;

FIG. 6 is a diagram illustrating a user interface presented via a display according to another aspect of the subject matter described herein; and

FIG. 7 is a diagram illustrating a user interface selection control presented via a display according to another aspect of the subject matter described herein.

### DETAILED DESCRIPTION

One or more aspects of the disclosure are described with reference to the drawings, wherein like reference numerals are generally utilized to refer to like elements throughout, and wherein the various structures are not necessarily drawn to scale. In the following description, for purposes of explanation, numerous specific details are set forth in order to provide a thorough understanding of one or more aspects of the disclosure. It may be evident, however, to one skilled in the art, that one or more aspects of the disclosure may be practiced with a lesser degree of these specific details. In other instances, well-known structures and devices are shown in block diagram form in order to facilitate describing one or more aspects of the disclosure.

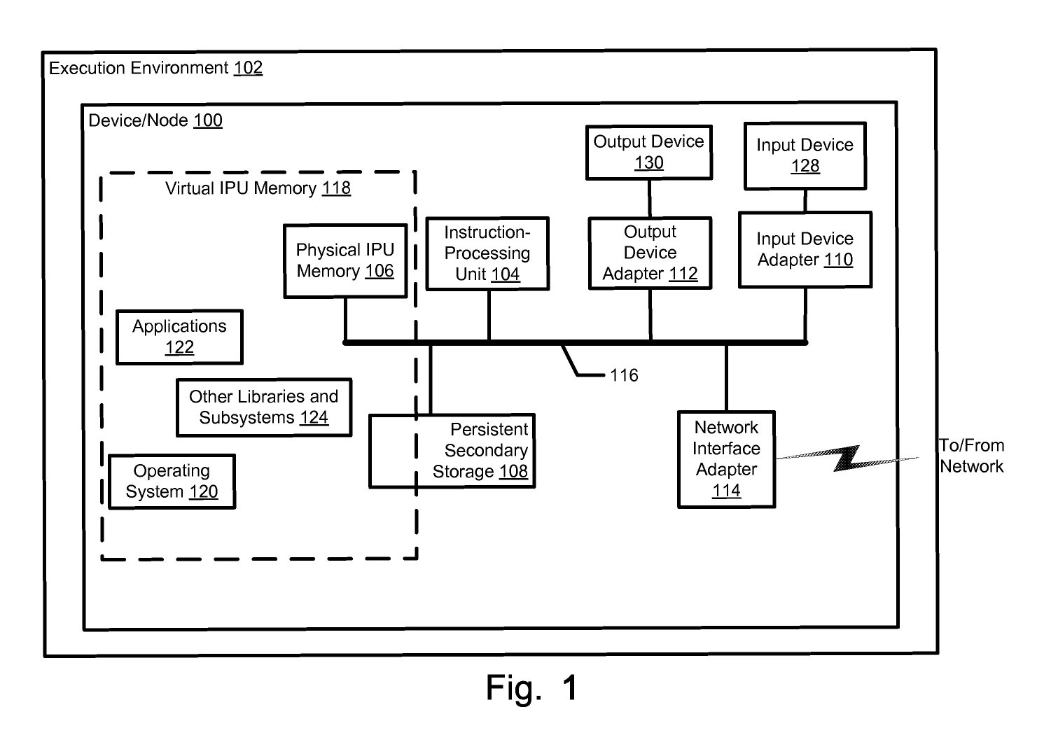

An exemplary device included in an execution environment that may be configured according to the subject matter is illustrated in FIG. 1. An execution environment includes an arrangement of hardware and, optionally, software that may be further configured to include an arrangement of components for performing a method of the subject matter described herein. An execution environment includes and/or is otherwise provided by one or more devices. An execution environment may include a virtual execution environment including software components operating in a host execution environment. Exemplary devices included in and/or otherwise providing suitable execution environments for configuring according to the subject matter include personal computers, notebook computers, tablet computers, servers, handheld and other mobile devices, multiprocessor devices, distributed devices and/or systems, consumer electronic devices, routers, communication servers, and/or other network-enabled devices. Those skilled in the art will understand that the components illustrated in FIG. 1 are exemplary and may vary by particular execution environment.

FIG. 1 illustrates hardware device 100 included in execution environment 102. FIG. 1 illustrates that execution environment 102 includes instruction-processing unit (IPU) 104, such as one or more microprocessors; physical IPU memory 106 including storage locations identified by addresses in a physical memory address space of IPU 104; persistent secondary storage 108, such as one or more hard drives and/or flash storage media; input device adapter 110, such as a key or keypad hardware, a keyboard adapter, and/or a mouse adapter; output device adapter 112, such as a display and/or an audio adapter for presenting information to a user; a network interface component, illustrated by network interface adapter 114, for communicating via a network such as a LAN and/or WAN; and a communication mechanism that couples elements 104-114, illustrated as bus 116. Elements 104-114 may be operatively coupled by various means. Bus 116 may comprise any type of bus architecture, including a memory bus, a peripheral bus, a local bus, and/or a switching fabric.

IPU 104 is an instruction execution machine, apparatus, or device. Exemplary IPUs include one or more microprocessors, digital signal processors (DSPs), graphics processing units, application-specific integrated circuits (ASICs), and/or field programmable gate arrays (FPGAs). In the description of the subject matter herein, the terms “IPU” and “processor” are used interchangeably. IPU 104 may access machine code instructions and data via one or more memory address spaces in addition to the physical memory address space. A memory address space includes addresses identifying locations in a processor memory. The addresses in a memory address space are included in defining a processor memory. IPU 104 may have more than one processor memory. Thus, IPU 104 may have more than one memory address space. IPU 104 may access a location in a processor memory by processing an address identifying the location. The processed address may be in an operand of a machine code instruction and/or may be identified in a register or other portion of IPU 104.

FIG. 1 illustrates virtual IPU memory 118 spanning at least part of physical IPU memory 106 and at least part of persistent secondary storage 108. Virtual memory addresses in a memory address space may be mapped to physical memory addresses identifying locations in physical IPU memory 106. An address space for identifying locations in a virtual processor memory is referred to as a virtual memory address space; its addresses are referred to as virtual memory addresses; and its IPU memory is referred to as a virtual IPU memory or virtual memory. The terms “IPU memory” and “processor memory” are used interchangeably herein. Processor memory may refer to physical processor memory, such as IPU memory 106, and/or may refer to virtual processor memory, such as virtual IPU memory 118, depending on the context in which the term is used.

Physical IPU memory 106 may include various types of memory technologies. Exemplary memory technologies include static random access memory (SRAM) and/or dynamic RAM (DRAM) including variants such as dual data rate synchronous DRAM (DDR SDRAM), error correcting code synchronous DRAM (ECC SDRAM), and/or RAMBUS DRAM (RDRAM). Physical IPU memory 106 may include volatile memory as illustrated in the previous sentence and/or may include nonvolatile memory such as nonvolatile flash RAM (NVRAM) and/or ROM.

Persistent secondary storage 108 may include one or more flash memory storage devices, one or more hard disk drives, one or more magnetic disk drives, and/or one or more optical disk drives. Persistent secondary storage may include removable media. The drives and their associated computer-readable storage media provide volatile and/or nonvolatile storage for computer-readable instructions, data structures, program components, and other data for execution environment 102.

Execution environment 102 may include software components stored in persistent secondary storage 108, in remote storage accessible via a network, and/or in a processor memory. FIG. 1 illustrates execution environment 102 including operating system 120, one or more applications 122, and other program code and/or data components illustrated by other libraries and subsystems 124. In an aspect, some or all software components may be stored in locations accessible to IPU 104 in a shared memory address space shared by the software components. The software components accessed via the shared memory address space are stored in a shared processor memory defined by the shared memory address space. In another aspect, a first software component may be stored in one or more locations accessed by IPU 104 in a first address space and a second software component may be stored in one or more locations accessed by IPU 104 in a second address space. The first software component is stored in a first processor memory defined by the first address space and the second software component is stored in a second processor memory defined by the second address space.

Software components typically include instructions executed by IPU 104 in a computing context referred to as a “process”. A process may include one or more “threads”. A “thread” includes a sequence of instructions executed by IPU 104 in a computing sub-context of a process. The terms “thread” and “process” may be used interchangeably herein when a process includes only one thread.

Execution environment 102 may receive user-provided information via one or more input devices illustrated by input device 128. Input device 128 provides input information to other components in execution environment 102 via input device adapter 110. Execution environment 102 may include an input device adapter for a keyboard, a touch screen, a microphone, a joystick, a television receiver, a video camera, a still camera, a document scanner, a fax, a phone, a modem, a network interface adapter, and/or a pointing device, to name a few exemplary input devices.

Input device 128 included in execution environment 102 may be included in device 100 as FIG. 1 illustrates or may be external (not shown) to device 100. Execution environment 102 may include one or more internal and/or external input devices. External input devices may be connected to device 100 via corresponding communication interfaces such as a serial port, a parallel port, and/or a universal serial bus (USB) port. Input device adapter 110 receives input and provides a representation to bus 116 to be received by IPU 104, physical IPU memory 106, and/or other components included in execution environment 102.

Output device 130 in FIG. 1 exemplifies one or more output devices that may be included in and/or may be external to and operatively coupled to device 100. For example, output device 130 is illustrated connected to bus 116 via output device adapter 112. Output device 130 may be a display device. Exemplary display devices include liquid crystal displays (LCDs), light emitting diode (LED) displays, and projectors. Output device 130 presents output of execution environment 102 to one or more users. In some embodiments, an input device may also include an output device. Examples include a phone, a joystick, and/or a touch screen. In addition to various types of display devices, exemplary output devices include printers, speakers, tactile output devices such as motion-producing devices, and other output devices producing sensory information detectable by a user.

A device included in and/or otherwise providing an execution environment may operate in a networked environment communicating with one or more devices via one or more network interface components. The terms “communication interface component” and “network interface component” are used interchangeably herein. FIG. 1 illustrates network interface adapter (NIA) 114 as a network interface component included in execution environment 102 to operatively couple device 100 to a network. A network interface component includes a network interface hardware (NIH) component and optionally a software component.

Exemplary network interface components include network interface controller components, network interface cards, network interface adapters, and line cards. A node may include one or more network interface components to interoperate with a wired network and/or a wireless network. Exemplary wireless networks include a BLUETOOTH network, a wireless 802.11 network, and/or a wireless telephony network (e.g., a cellular, PCS, CDMA, and/or GSM network). Exemplary network interface components for wired networks include Ethernet adapters, Token-ring adapters, FDDI adapters, asynchronous transfer mode (ATM) adapters, and modems of various types. Exemplary wired and/or wireless networks include various types of LANs, WANs, and/or personal area networks (PANs). Exemplary networks also include intranets and internets such as the Internet.

The terms “network node” and “node” in this document both refer to a device having a network interface component for operatively coupling the device to a network. Further, the terms “device” and “node” as used herein refer to one or more devices and nodes, respectively, providing and/or otherwise included in an execution environment unless clearly indicated otherwise.

The components of a user interface are generically referred to herein as “user interface elements”. More specifically, visual components of a user interface are referred to herein as “visual interface elements”. A visual interface element may be a visual component of a graphical user interface (GUI). Exemplary visual interface elements include windows, textboxes, sliders, list boxes, drop-down lists, spinners, various types of menus, toolbars, ribbons, combo boxes, tree views, grid views, navigation tabs, scrollbars, labels, tooltips, text in various fonts, balloons, dialog boxes, and various types of button controls including check boxes and radio buttons. An application interface may include one or more of the elements listed. Those skilled in the art will understand that this list is not exhaustive. The terms “visual representation”, “visual component”, and “visual interface element” are used interchangeably in this document. Other types of user interface elements include audio output components referred to as “audio interface elements”, tactile output components referred to as “tactile interface elements”, and the like.

A visual component may be presented in a two-dimensional presentation where a location may be defined in a two-dimensional space having a vertical dimension and a horizontal dimension. A location in a horizontal dimension may be referenced according to an X-axis and a location in a vertical dimension may be referenced according to a Y-axis. In another aspect, a visual component may be presented in a three-dimensional presentation where a location may be defined in a three-dimensional space having a depth dimension in addition to a vertical dimension and a horizontal dimension. A location in a depth dimension may be identified according to a Z-axis. A visual component in a two-dimensional presentation may be presented as if a depth dimension existed, allowing the visual component to overlie and/or underlie some or all of another visual component.

An order of visual components in a depth dimension is herein referred to as a “Z-order”. The term “Z-value” as used herein refers to a location in a Z-order, or an order of visual components along a Z-axis. A Z-order specifies the front-to-back ordering of visual components in a presentation space. A visual component with a higher Z-value than another visual component may be defined as being on top of or closer to the front than the other visual component.

A “user interface (UI) element handler” component, as the term is used in this document, includes a component configured to send information representing a program entity for presenting a user-detectable representation of the program entity by an output device, such as a display. A “program entity” is an object included in and/or otherwise processed by an application or executable. The user-detectable representation is presented based on the sent information. The sent information is referred to herein as “presentation information”. Presentation information may include data in one or more formats. Exemplary formats include image formats such as JPEG, video formats such as MP4, markup language data such as HTML and other XML-based markup, and/or instructions such as those defined by various script languages, byte code, and/or machine code. For example, a web page received by a browser from a remote application provider may include hypertext markup language (HTML), ECMAScript, and/or byte code for presenting one or more user interface elements included in a user interface of the remote application. Components configured to send information representing one or more program entities for presenting particular types of output by particular types of output devices include visual interface element handler components, audio interface element handler components, tactile interface element handler components, and the like.

A representation of a program entity may be stored and/or otherwise maintained in a presentation space. As used in this document, the term “presentation space” refers to a storage region allocated and/or otherwise provided for storing presentation information, which may include audio, visual, tactile, and/or other sensory data for presentation by and/or on an output device. For example, a buffer for storing an image and/or text string may be a presentation space. A presentation space may be physically and/or logically contiguous or non-contiguous. A presentation space may have a virtual as well as a physical representation. A presentation space may include a storage location in a processor memory, persistent secondary storage, a memory of an output adapter device, and/or a storage medium of an output device. A screen of a display, for example, includes a presentation space.

As used herein, the term “program” or “executable” refers to any data representation that may be translated into a set of machine code instructions and optionally associated program data. Thus, a program or executable may include an application, a shared or non-shared library, and/or a system command. Program representations other than machine code include object code, byte code, and source code. Object code includes a set of instructions and/or data elements that either are prepared for linking prior to loading or are loaded into an execution environment. When in an execution environment, object code may include references resolved by a linker and/or may include one or more unresolved references. The context in which this term is used will make clear that state of the object code when it is relevant. This definition can include machine code and virtual machine code, such as Java™ byte code.

As used herein, an “addressable entity” is a portion of a program, specifiable in programming language in source code. An addressable entity is addressable in a program component translated for a compatible execution environment from the source code. Examples of addressable entities include variables, constants, functions, subroutines, procedures, modules, methods, classes, objects, code blocks, and labeled instructions. A code block includes one or more instructions in a given scope specified in a programming language. An addressable entity may include a value. In some places in this document “addressable entity” refers to a value of an addressable entity. In these cases, the context will clearly indicate that the value is being referenced.

Addressable entities may be written in and/or translated to a number of different programming languages and/or representation languages, respectively. An addressable entity may be specified in and/or translated into source code, object code, machine code, byte code, and/or any intermediate language(s) for processing by an interpreter, compiler, linker, loader, and/or analogous tool.

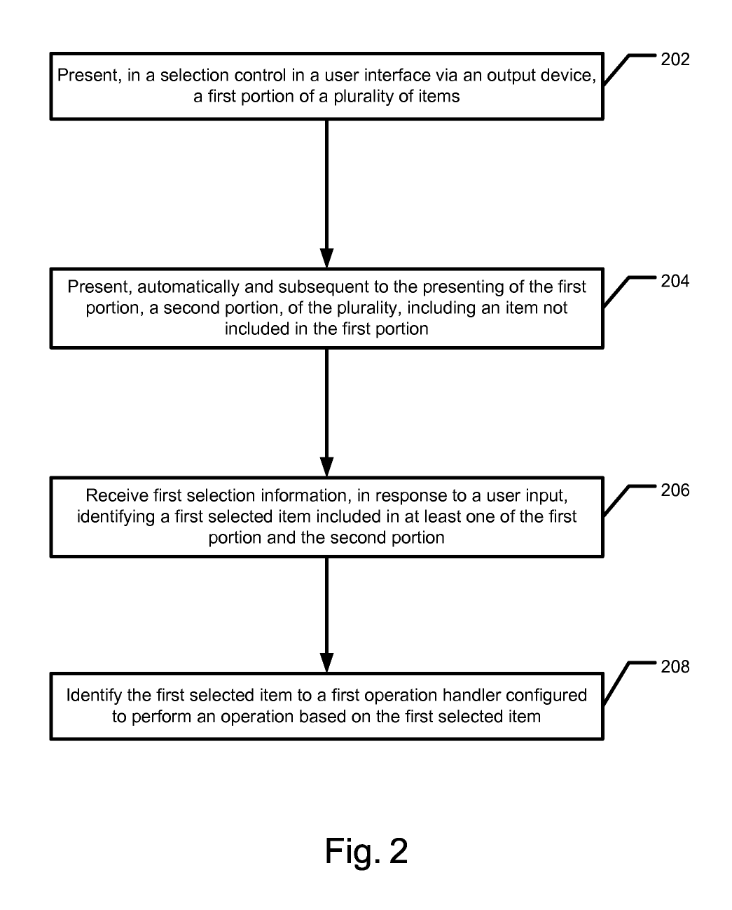

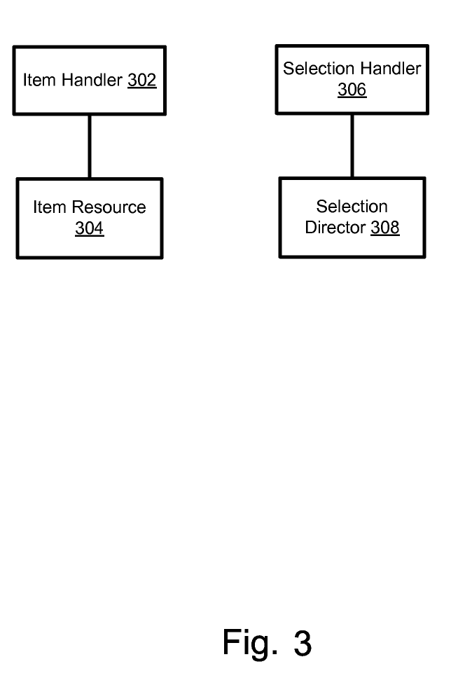

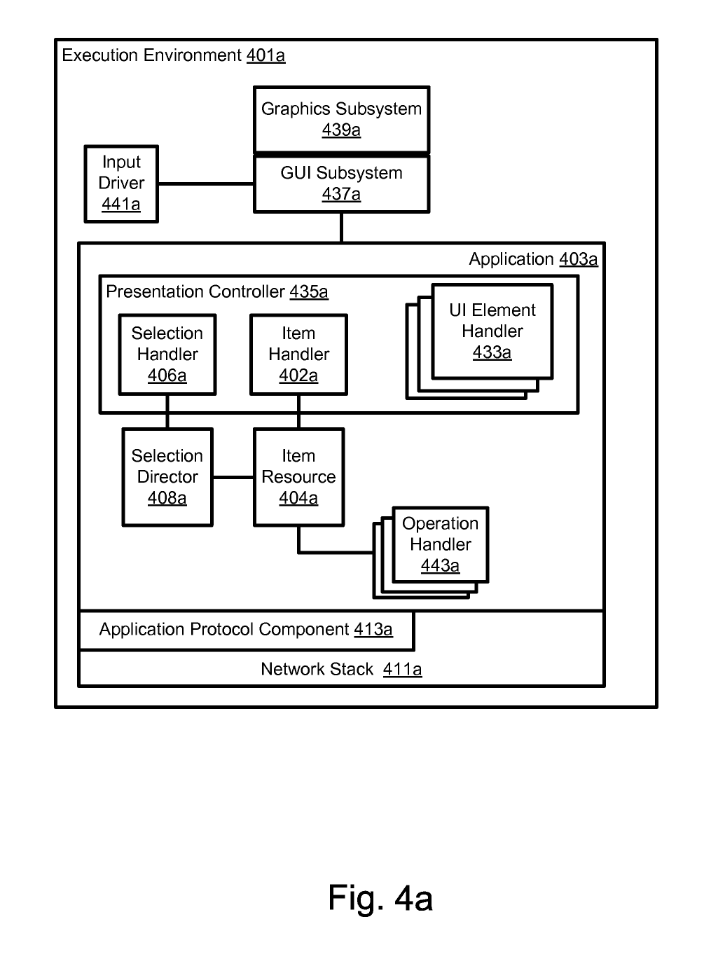

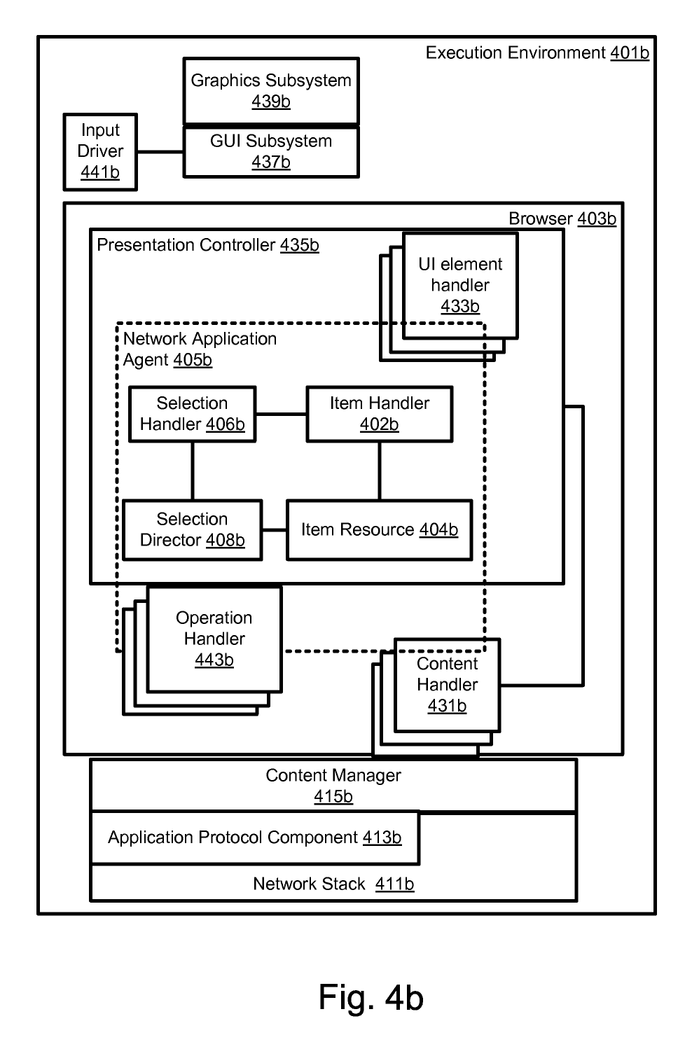

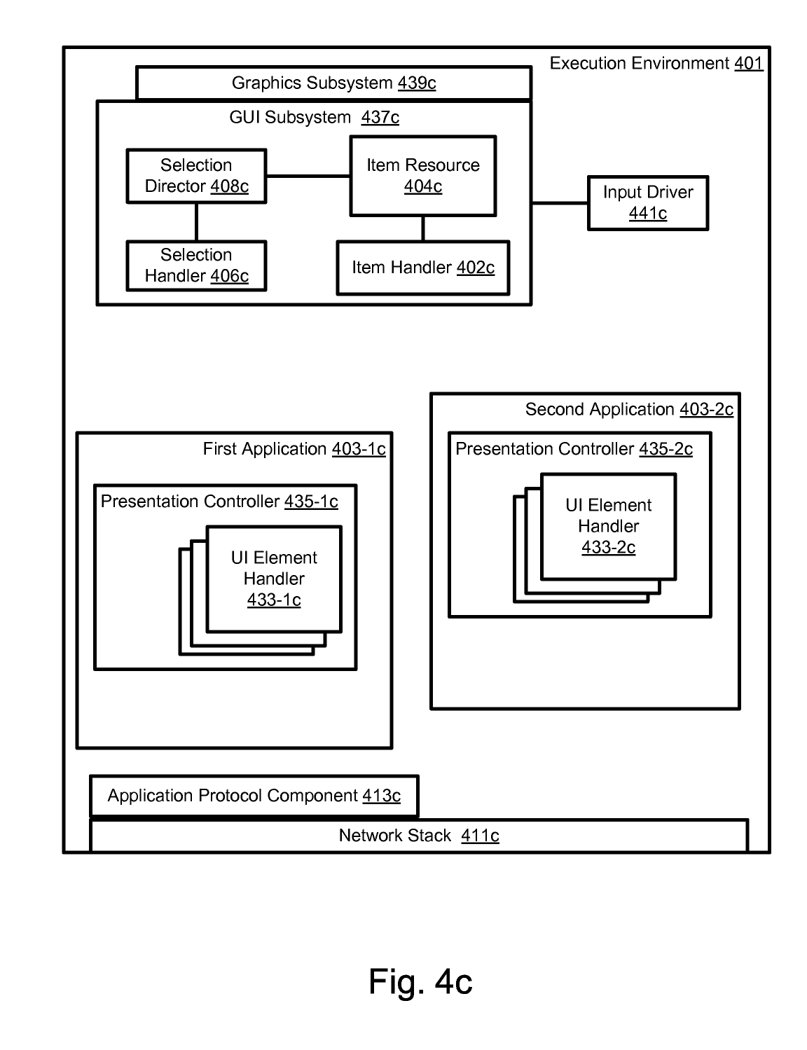

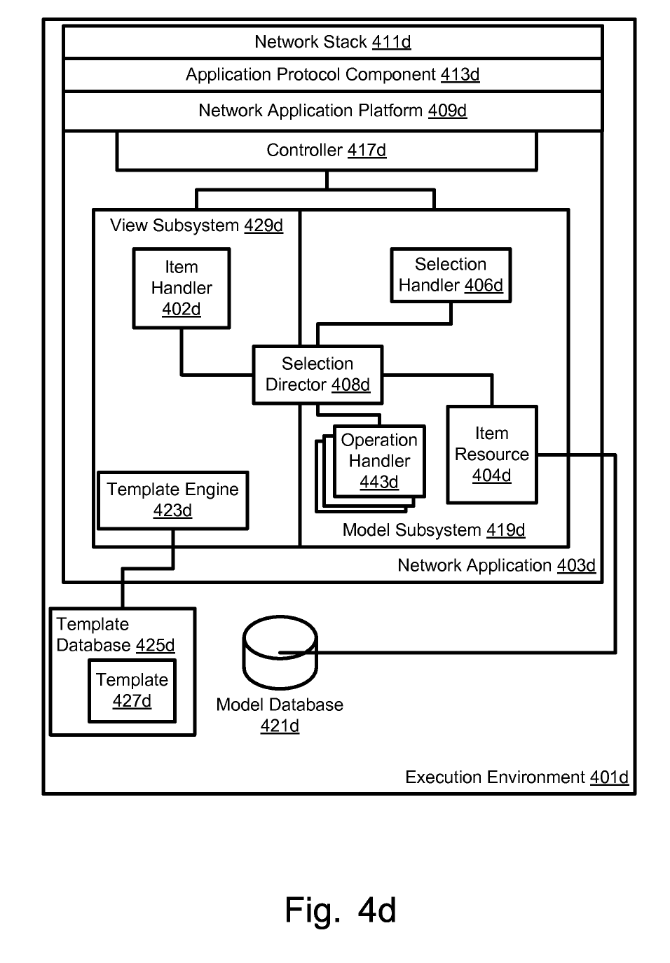

The block diagram in FIG. 3 illustrates an exemplary system for automatically scrolling items in a selection control according to the method illustrated in FIG. 2. FIG. 3 illustrates a system, adapted for operation in an execution environment, such as execution environment 102 in FIG. 1, for performing the method illustrated in FIG. 2. The system illustrated includes an item handler component 302, an item resource component 304, a selection handler component 306, and a selection director component 308. The execution environment includes an instruction-processing unit, such as IPU 104, for processing an instruction in at least one of the item handler component 302, the item resource component 304, the selection handler component 306, and the selection director component 308. Some or all of the exemplary components illustrated in FIG. 3 may be adapted for performing the method illustrated in FIG. 2 in a number of execution environments. FIGS. 4a-d include block diagrams illustrating the components of FIG. 3 and/or analogs of the components of FIG. 3 adapted for operation in various execution environments 401 including or otherwise provided by one or more devices.

FIG. 1 illustrates components of an exemplary device that may at least partially provide and/or otherwise be included in an execution environment. The components illustrated in FIGS. 4a-d may be included in or otherwise combined with the components of FIG. 1 to create a variety of arrangements of components according to the subject matter described herein.

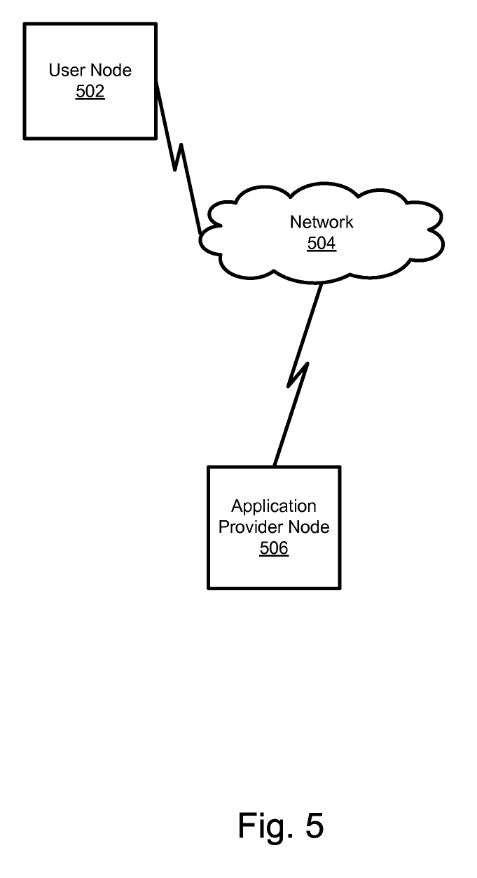

FIG. 5 illustrates user node 502 as an exemplary device that in various aspects may be included in and/or otherwise adapted for providing any of execution environments 401, illustrated in FIGS. 4a-c, each illustrating a different adaptation of the arrangement of components in FIG. 3. As illustrated in FIG. 5, user node 502 is operatively coupled to network 504 via a network interface component, such as network interface adapter 114. Alternatively or additionally, an adaptation of an execution environment 401 may include and/or may otherwise be provided by a device that is not operatively coupled to a network.

A server device is illustrated by application provider node 506. Application provider node 506 may be included in and/or otherwise adapted for providing execution environment 401d illustrated in FIG. 4d. As illustrated in FIG. 5, application provider node 506 is operatively coupled to network 504 via a network interface component included in execution environment 401d.

FIG. 4a illustrates execution environment 401a hosting application 403a including an adaptation of the arrangement of components in FIG. 3. FIG. 4b illustrates execution environment 401b hosting browser 403b including an adaptation of the arrangement of components in FIG. 3 that may operate at least partially in a network application agent 405b received from a remote application provider, such as network application 403d in FIG. 4d. Browser 403b and execution environment 401b may provide at least part of an execution environment for network application agent 405b that may be received via a network from a network application operating in a remote execution environment. FIG. 4c illustrates an adaptation of the arrangement in FIG. 3 adapted to operate in GUI subsystem 437c in execution environment 401c. The arrangement in FIG. 4c may mediate communication between applications, illustrated by first application 403-1c and second application 403-2c, and one or more output devices, such as output device 130 in FIG. 1.

FIG. 4d illustrates execution environment 401d configured to host one or more network applications, such as a web service, illustrated by network application 403d. FIG. 4d also illustrates network application platform 409d that may provide services to one or more network applications. Network application 403d includes yet another adaptation of the arrangement of components in FIG. 3.

The various adaptations of the arrangement in FIG. 3 that are described herein are not exhaustive. For example, those skilled in the art will see based on the description herein that arrangements of components for performing the method illustrated in FIG. 2 may be at least partially included in an application and at least partially external to the application. Further, arrangements for performing the method illustrated in FIG. 2 may be distributed across more than one node and/or execution environment. For example, such an arrangement may operate at least partially in browser 403b in FIG. 4b and at least partially in execution environment 401d in and/or external to network application 403d.

FIGS. 4a-d illustrate adaptations of network stacks 411 configured for sending and receiving messages over a network, such as network 504, via a network interface component. Network application platform 409d in FIG. 4d provides a service to one or more network applications. In various aspects, network application platform 409d may include and/or interoperate with a web server. FIG. 4d also illustrates network application platform 409d configured for interoperating with network stack 411d.

Network stacks 411 may support the same protocol suite, such as TCP/IP, or may communicate via a network gateway or other protocol translation device and/or service. For example, browser 403b in FIG. 4b and network application platform 409d in FIG. 4d may interoperate via their respective network stacks: network stack 411b and network stack 411d.

FIGS. 4a-d illustrate applications 403, respectively, which may communicate via one or more application layer protocols. FIGS. 4a-d respectively illustrate application protocol components 413 for communicating via one or more application layer protocols. Exemplary application layer protocols include hypertext transfer protocol (HTTP) and instant messaging and presence (XMPP-IM) protocol. Matching protocols enabling applications 403 to communicate via network 504 in FIG. 5 are not required, if communication is via a protocol gateway or other translator.

In FIG. 4b, browser 403b may receive some or all of network application agent 405b in one or more messages sent from a network application, such as network application 403d via network application platform 409d, a network stack 411, a network interface component, and optionally an application protocol component 413. In FIG. 4b, browser 403b includes content manager component 415b. Content manager component 415b may interoperate with one or more of application protocol component 413b and/or network stack 411b to receive the message or messages including some or all of network application agent 405b.

Network application agent 405b may include a web page, such as an HTML document, for presenting a user interface for network application 403d. The web page may include and/or reference data represented in one or more formats including hypertext markup language (HTML) and/or other markup language, ECMAScript or other scripting language, byte code, image data, audio data, and/or machine code.

In an aspect, in response to a request received from browser 403b in FIG. 4b operating in user node 502 in FIG. 5, controller component 417d in FIG. 4d, operating in application provider node 506, may invoke model subsystem 419d to perform request-specific processing. Model subsystem 419d may include any number of request handlers (not shown) for dynamically generating data and/or retrieving data from model database 421d based on the request. Controller component 417d may further invoke template engine 423d to identify one or more templates and/or static data elements for generating a user interface for representing a response to the received request. FIG. 4d illustrates template database 425d including exemplary template 427d. FIG. 4d illustrates template engine 423d as a component in view subsystem 429d configured to return responses to processed requests in a presentation format suitable for a client, such as browser 403b. View subsystem 429d may provide the presentation information to controller component 417d to send to browser 403b in response to the request received from browser 403b. Some or all of network application agent 405b may be sent to browser 403b via network application platform 409d as described above.

While the previous paragraph describes sending some or all of network application agent 405b in response to a request, network application 403d additionally or alternatively may send some or all of a network application agent to browser 403b via one or more asynchronous messages. In an aspect, an asynchronous message may be sent in response to a change detected by network application 403d. Publish-subscribe protocols, such as the presence protocol specified by XMPP-IM, are exemplary protocols for sending messages asynchronously.

The one or more messages including information representing some or all of network application agent 405b in FIG. 4b may be received by content manager component 415b via one or more of application protocol component 413b and network stack 411b as described above. In FIG. 4b, browser 403b includes one or more content handler components 431b to process received data according to its data type, typically identified by a MIME-type identifier. Exemplary content handler components 431b include a text/html content handler component for processing HTML documents; an application/xmpp-xml content handler component for processing XMPP streams including presence tuples, instant messages, and publish-subscribe data as defined by various XMPP specifications; one or more video content handler components for processing video streams of various types; and still image data content handler components for processing various images types. Content handler components 431b process received data and may provide a representation of the processed data to one or more user interface (UI) element handler components 433b.

UI element handler components 433 are respectively illustrated in presentation controller components 435 in FIG. 4a, FIG. 4b, and FIG. 4c. A presentation controller component 435 may manage visual, audio, and/or other types of output of its including application 403 as well as receive and route detected user and other inputs to components and extensions of its including application 403. With respect to FIG. 4b, a UI element handler component 433b in various aspects may be adapted to operate at least partially in a content handler component 431b such as a text/html content handler component and/or a script content handler component. Additionally or alternatively, a UI element handler component 433 in an execution environment 401 may operate in and/or as an extension of its including application 403. For example, a plug-in may provide a virtual machine, for a UI element handler component received as a script and/or byte code, that may operate as an extension of an application 403 and/or external to and interoperating with an application 403.

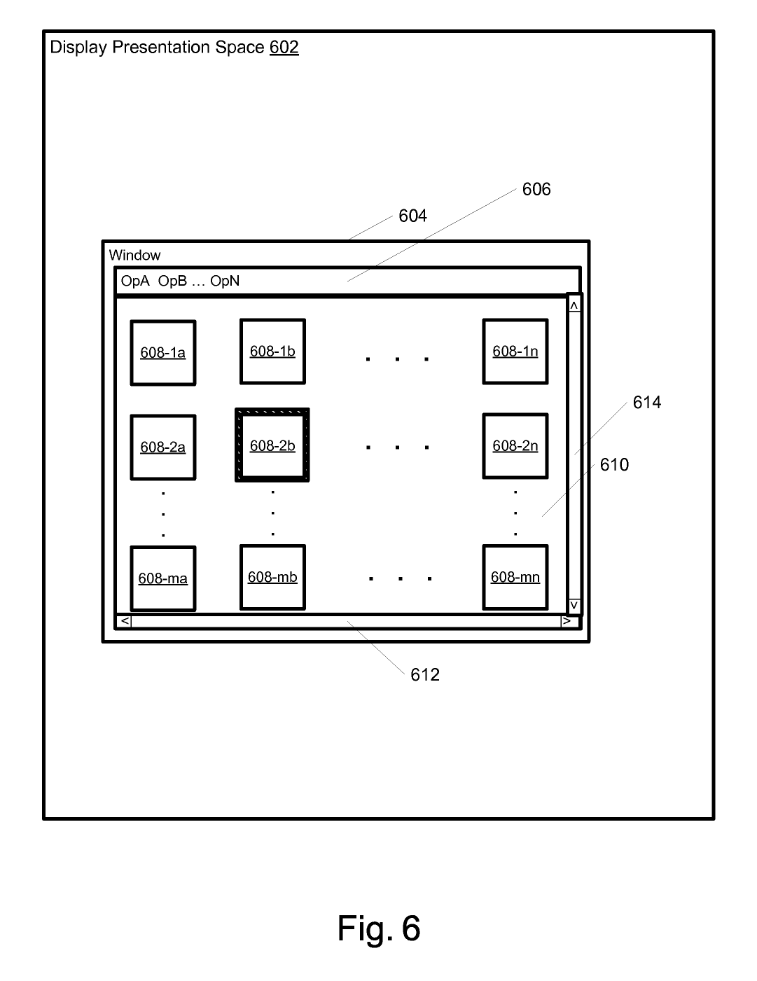

FIG. 6 illustrates display presentation space 602 of a display in and/or operatively coupled to a device, such as user node 502 in FIG. 5. FIG. 6 illustrates window 604 in display presentation space 602. Window 604 illustrated in FIG. 6 is described as a user interface of various applications 403 and other components illustrated in FIGS. 4a-d in describing the subject matter herein. In an aspect, window 604 may be provided as a user interface of multiple applications 403 interoperating. For example, window 604 and/or a visual component included in window 604 may be presented via interoperation of browser 403b, network application agent 405b, and network application 403d illustrated in FIG. 4b and FIG. 4d. Browser 403b may operate in user node 502 and network application 403d may operate in application provider node 506. Network application agent 405b may be provided to user node 502 by application provider node 506 via network 504, as described above.

Window 604 illustrates a number of visual user interface elements commonly found in applications. Window 604 includes operation bar 606 with operation user interface controls for receiving corresponding user input to identify operations to perform on one or more selectable items 608 represented in a presentation space 610 in a user interface element in window 604. Presentation space 610 is scrollable horizontally as indicated by horizontal scrollbar 612 and vertically as indicated by vertical scrollbar 614. Window 604, in an aspect, may be presented by an application including a browser, such as browser 403b in FIG. 4b. A browser window may include a user interface of a network application provided by a remote node, such as network application 403d in FIG. 4d. Browser windows, as well as other application user interfaces, may include location bars (not shown) identifying a universal resource identifier (URI) for content presented in presentation space 610.

Various UI elements of applications 403 described above may be presented by one or more UI element handler components 433 in FIGS. 4a-c and/or by one or more template engines 423d in FIG. 4d. In an aspect, illustrated in FIGS. 4a-c, UI element handler component(s) 433 of one or more applications 403 is/are configured to send presentation information representing a visual interface element, such as operation bar 606 in FIG. 6, to a GUI subsystem 437. A GUI subsystem 437 may instruct a graphics subsystem 439 to draw the visual interface element in a region of display presentation space 602, based on presentation information received from a UI element handler component 433.

Input may be received corresponding to a UI element via an input driver 441 illustrated in FIGS. 4a-c in various adaptations. For example, a user may move a mouse to move a pointer presented in display presentation space 602 in FIG. 6 over an operation user interface element presented in an operation bar 606. A user may provide an input detected by the mouse. The detected input may be received by a GUI subsystem 437 via an input driver 441 as an operation or command indicator based on the association of the shared location of the pointer and the operation user interface element in display presentation space 602.

With reference to FIG. 2, block 202 illustrates that the method includes presenting, in a selection control in a user interface via an output device, a first portion of a plurality of items. Accordingly, a system for automatically scrolling items in a selection control includes means for presenting, in a selection control in a user interface via an output device, a first portion of a plurality of items. For example, as illustrated in FIG. 3, item handler component 302 is configured for presenting, in a selection control in a user interface via an output device, a first portion of a plurality of items. FIGS. 4a-d illustrate item handler components 402 as adaptations and/or analogs of item handler component 302 in FIG. 3. One or more item handler components 402 operate in execution environments 401.

In FIG. 4a, item handler component 402a is illustrated as a component of application 403a. In FIG. 4b, item handler component 402b is illustrated as a component of network application agent 405b. In FIG. 4c, item handler component 402c is illustrated operating external to one or more applications 403c. Execution environment 401c includes item handler component 402c in GUI subsystem 437c. In FIG. 4d, item handler component 402d is illustrated operating in network application 403d remote from a display device for presenting and/or updating a visual component. For example, item handler component 402d may operate in application provider node 506 while a visual component is presented via a display device of user node 502 based on presentation information sent via network 504 from application provider node 506.

In various aspects, an item resource component 404 illustrated in FIGS. 4a-d may receive item information for some or all of a plurality of items. The item resource component 404 may provide item information and/or information based on the item information to a corresponding item handler component 402. The item handler component 402 may transform the item information, if needed, into a representation suitable for sending to an output device for presenting. An item may represent any program entity processed by a program including and/or otherwise interoperating with an item handler component 402. An item handler component 402 may be included in and/or otherwise operatively coupled to a user interface element handler 433 for presenting a selection control via an output device.

A selection control is a user interface element for presenting one or more selectable user interface elements, referred to herein as items. For example, a window including a scrollable presentation space for presenting selectable items is a selection control. Window 604 in FIG. 6 illustrates a selection control that may be presented by a user interface element handler 433. An item handler component 402 may send and/or otherwise provide presentation information for a portion of a plurality of items for presenting in a selection control, such as window 604. One or more inputs may be received from a user for identifying one or more items presented in a selection control for selection.

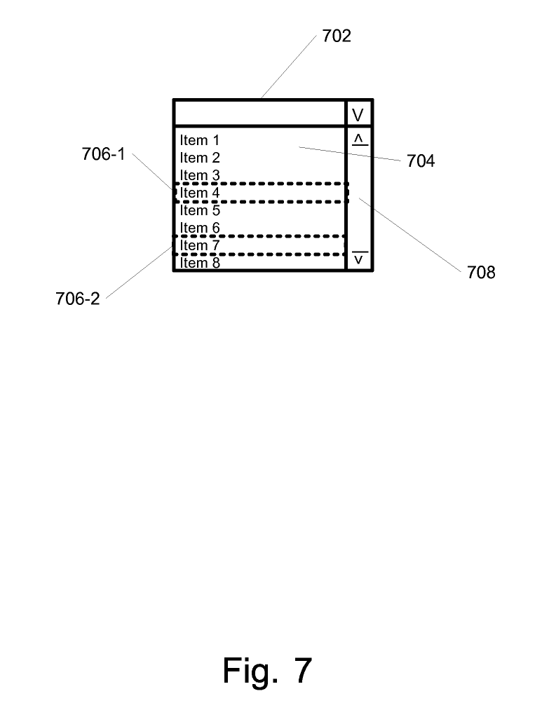

FIG. 4a illustrates item handler component 402a operating in presentation controller 435a of application 403a. Item handler component 402a may include and/or may be included in a user interface element handler 433a for presenting a selection control including selectable items in a portion of a plurality of items. In an aspect, item handler component 402a may present a portion of a plurality of items in drop-down menu 702 illustrated in FIG. 7. FIG. 7 illustrates a presentation space 704 in drop-down menu 702 for presenting one or more items 706 for selecting by a user.

FIG. 4b illustrates item handler component 402b included in network application agent 405b received, at least in part, via network 504 from network application 403d operating in application provider node 506. Item handler component 402b may include executable instructions in a script, markup language such as HTML, a style sheet, and/or other resources for presenting a selection control in, for example, a window and/or tab of a user interface of browser 403b. Item handler component 402b may include and/or be included in a user interface element handler 433b included in browser 403b and/or at least partially received from network application 403d. Alternatively or additionally, item handler component 402b may interoperate with one or more user interface element handlers 433b included in browser 403b and/or in an extension of browser 403b. In an aspect, item handler component 402b may receive item information from item resource component 404b to present a portion of items, illustrated in FIG. 6 as selectable items 608. The item information may be received from network application 403d operating in application provider node 506, may be received from a user of browser 403b, may be included in network application agent 405b, and/or may be received from any other suitable source.

In FIG. 4d item handler component 402d is illustrated in view subsystem 429d of network application 403d. Item handler component 402d may provide presentation information as described above in various formats for presenting a selection control by browser 403b and/or network application agent 405b. Item handler component 402d may present selectable items 608 in FIG. 6 via browser 403b operating in user node 502. In an aspect, item handler component 402d may interoperate with a browser including an adaption of the arrangement of components illustrated in FIG. 3. In another aspect, item handler component 402d may interoperate with a browser that is not adapted to perform the method illustrated in FIG. 2.

Returning to FIG. 2, block 204 illustrates that the method further includes, presenting, automatically and subsequent to the presenting of the first portion, a second portion, of the plurality, including an item not included in the first portion. Accordingly, a system for automatically scrolling items in a selection control includes means for presenting, automatically and subsequent to the presenting of the first portion, a second portion, of the plurality, including an item not included in the first portion. For example, as illustrated in FIG. 3, item resource component 304 is configured for presenting, automatically and subsequent to the presenting of the first portion, a second portion, of the plurality, including an item not included in the first portion. FIGS. 4a-d illustrate item resource components 404 as adaptations and/or analogs of item resource component 304 in FIG. 3. One or more item resource components 404 operate in execution environments 401.

In various aspects, item resource components 404 in FIGS. 4a-d may receive additional item information for some or all of a plurality of items and/or otherwise may have access to some item information previously received that has not yet been presented in a first portion of the plurality currently presented in a selection control. An item resource component 404, as described above, may provide item information and/or information based on item information to a corresponding item handler component 402 for presenting another subset or portion of the plurality of items in the selection control. The item handler component 402 may automatically present the other portion of the plurality of items to a user in the selection control after presenting the first portion.

An input for selecting one or more items included in the first portion may or may not be received prior to presenting the second portion. Presentation of the second portion may be performed by an item handler component without user input for scrolling. That is, presentation of the second portion is automatic. In FIGS. 4a-c, a start scroll indicator may be received by a presentation controller component 435. In FIG. 4d a start scroll indicator may be received by a request handler (not shown). A start scroll indicator may correspond to one or both of horizontal scrollbar 612 and vertical scrollbar 614 in FIG. 6. In response to receiving a start scroll indicator, a corresponding item resource component 404 may be invoked to interoperate with an item handler component 402 to initiate automatic scrolling. A previous portion, including an item not included in the first portion, of the plurality of items may be visible when the start scroll indicator is received prior to presentation of the first portion of the plurality. In response, the item handler component 402 may present the first portion including an item not included in the previous portion. The second portion is subsequently presented without receiving scrolling input after receiving the start scroll indicator. In a further aspect, an input may be received corresponding to one or both of horizontal scrollbar 612 and vertical scrollbar 614 to adjust a rate of automatic scrolling, to pause automatic scrolling, and/or to stop automatic scrolling.

In an aspect, window 604 may be presented as a selection control without navigation controls such as horizontal scrollbar 612 and vertical scrollbar 614. An item handler component 402 and/or item resource component 404 may initiate scrolling automatically in response to the presenting of the window 604. Scrolling may be initiated in response to the presenting of a selection control, in response to the presenting of one or more items in a plurality of selectable items, in response detection of a timer expiration, in response to detection of a particular time, in response to detection that a selection control's presentation space for presenting items is full and/or has reached a specified threshold based on a count of items, in response to a change in a resource represented by an item, in response to a change in state of a selection control, in response to a change in state of an application presenting the selection control, and/or in response to a message from another application which may be an application operating at least partially in a remote node. Once scrolling is initiated, further scrolling input from a user is not received and/or is not required for scrolling to continue while one or more items are selected. For example, scrolling may be initiated in response to detecting that window 604 has input focus for an input device, and scrolling my be stopped or paused in response to detecting the input focus for the device is no longer assigned to window 604.

FIG. 4a illustrates item handler component 402a operating in presentation controller 435a of application 403a. Item handler component 402a may include and/or may be included in a user interface element handler 433a for presenting a selection control including selectable representations of the plurality of items. In an aspect, item handler component 402a may present a portion of a plurality of items in drop-down menu 702 illustrated in FIG. 7. A drop-down presentation space 704 is illustrated including a portion of a plurality of selectable items 706 representing corresponding resources. First selectable item 706-1 illustrates a selected item as indicated by a dotted line box including first selectable item 706-1. A drop input may be received by item handler component 402a for presenting the first portion of the plurality of items in drop-down presentation space 704. A second portion of the plurality is presented automatically in presentation space 704 subsequent to the presentation of the first portion. At least some of the items in the second portion are not included in the first portion.

FIG. 4b illustrates item handler component 402b included in network application agent 405b received, at least in part, via network 504 from network application 403d operating in application provider node 506. Item handler component 402b may include executable instructions such as in a script, a document represented in a markup language such as HTML, a style sheet, and/or other resources for presenting a selection control in a window or tab of a user interface of browser 403b. Item handler component 402b may include and/or be included in a user interface element handler component received from network application 403d. Alternatively or additionally, item handler component 402b may interoperate with one or more user interface element handlers 433b included in browser 403b and/or in an extension of browser 403b. Item resource component 404b may present a second portion of the plurality of items automatically via item handler component 402b in response to receiving a specified number of items, not included in the first portion, from application provider node 506.

The items may be sent by item handler component 402d in network application 403d without receiving user input from user node 502. For example, an item may represent a change to a resource accessible to network application 403d. A change may include creation, deletion, and/or modification of an existing resource. In FIG. 4d, item resource component 404d may be notified of and/or may otherwise detect changes to resources represented by items presented in a selection control by network application agent 405b operating in user node 502. Item resource component 404d may provide item information corresponding to a change in a resource to item handler component 402d. Item handler component 402d may translate and/or otherwise transform the item information into data suitable for processing by network application agent 405b and/or browser 403b. Item handler component 402d may interoperate with controller component 417d to send the data as presentation information to present one or more items in presenting the second portion of the items in the selection control.

Scrolling may be automatic in some or all scrollable directions and/or dimensions. Automatic scrolling may be automatic in a first dimension, for example, vertical scrolling, and may be manual requiring user input in a second dimension, for example, horizontal scrolling. Further, automatic scrolling may be automatic in a first direction, for example, scrolling down, and may be manual requiring user input in a second direction, for example, scrolling up. Automatic and manual scrolling may be activated and/or deactivated by a user in a direction and/or a dimension.

Returning to FIG. 2, block 206 illustrates that the method yet further includes receiving first selection information, in response to a user input, identifying a first selected item included in at least one of the first portion and the second portion. Accordingly, a system for automatically scrolling items in a selection control includes means for receiving first selection information, in response to a user input, identifying a first selected item included in at least one of the first portion and the second portion. For example, as illustrated in FIG. 3, selection handler component 306 is configured for receiving first selection information, in response to a user input, identifying a first selected item included in at least one of the first portion and the second portion. FIGS. 4a-d illustrate selection handler components 406 as adaptations and/or analogs of selection handler component 306 in FIG. 3. One or more selection handler components 406 operate in execution environments 401.

In various aspects a selection handler component 406 in FIGS. 4a-d may receive selection information in response to a detected user input for selecting an item presented in a selection control. The selection information may identify one or more selectable items in a plurality. Selection information may be received during a presentation of a first portion of the plurality of items presented, a presentation of a second portion including an item not included in the first portion, and/or a presentation of a portion presented previously to the first portion including an item not in the first portion. In an aspect, one item may be selected, while in another aspect selection of multiple items may be allowed.

In FIG. 4a, an input may be detected by input driver 441a. Input information, such as information identifying a key and/or a location with respect to a presentation space, may be provided by input driver 441a to GUI subsystem 437a. Based on the input information, GUI subsystem 437a may identify an application and send selection information, based on the input information, to the application. GUI subsystem 437a may provide input information to a component, such as presentation controller 435a for routing within application 403a as selection information. Alternatively or additionally, GUI subsystem 437a may provide selection information directly to one or more user interface element handlers 433a corresponding to one or more user interface elements that GUI subsystem 437a has determined correspond to the detected user input. Thus, in various aspects, selection handler component 406a may receive input information identifying a selected item directly and/or indirectly from a presentation subsystem. Selection handler component 406a may identify a selected item based on the received selection information. The item may be included in a first portion of the plurality presented for presentation and/or may be in a second portion of the plurality. In either case, the second portion is presented automatically subsequent to presentation of the first portion.

Input processing in execution environment 401b in FIG. 4b may be performed analogously. In an aspect, a user interface element handler 433b and/or presentation controller 435b may receive selection information corresponding to a presented selectable item. The information may be provided to selection handler component 406b for processing. Selection handler component 406b may perform all or some of the processing and/or may send a request to network application 403d to perform at least a portion of the processing of the selection information. Selection handler component 406b and/or selection handler component 406d may identify a selected item based on the received selection information. The item may be included in a first portion of a plurality presented for presentation and/or may be in a second portion of the plurality. In either case, the second portion is presented automatically subsequent to presentation of the first portion.

In FIG. 4d, selection handler component 406d is illustrated operating in model subsystem 419d. Selectable items may be presented for selection on a remote device such as user node 502. Selection handler component 406d operating in application provider node 506 may receive selection information identifying an item as selected via a message sent from user node 502. For example, browser 403b and/or network application agent 405b may send a message from user node 502 via network 504 to application provider node 506 to network application 403d. Controller 417d may receive at least some of a payload portion of the message including selection information. Based on a portion of the message, such as a URI, controller 417d may route the selection information to a request handler (not shown) in model subsystem 419d. Selection handler component 406d may include, may be included in, and/or may otherwise interoperate with the request handler identified by controller 417d. Selection handler component 406d may identify a selected item based on the received selection information. The item may be included in the first portion of the plurality presented for presentation and/or may be in the second portion of the plurality. In either case, the second portion is presented automatically subsequent to presentation of the first portion.

Returning to FIG. 2, block 208 illustrates that the method yet further includes identifying the first selected item to a first operation handler configured to perform an operation based on the first selected item. Accordingly, a system for automatically scrolling items in a selection control includes means for identifying the first selected item to a first operation handler configured to perform an operation based on the first selected item. For example, as illustrated in FIG. 3, selection director component 308 is configured for identifying the first selected item to a first operation handler configured to perform an operation based on the first selected item. FIGS. 4a-d illustrate selection director components 408 as adaptations and/or analogs of selection director component 308 in FIG. 3. One or more selection director components 408 operate in execution environments 401.

In various aspects a selection director component 408 in FIGS. 4a-d may identify the selected item for processing to one or more operation handlers. The processing may be application dependent and/or item dependent. In FIG. 4a, selection director component 408a may invoke and/or otherwise communicate with an operation handler component 443a to identify one or more selected items to perform an operation. In FIG. 4b in various aspects and adaptations, selection director component 408b may operate analogously. In an aspect, selection director component 408b may send a message to network application 403d identifying the selected item to one or more operation handler components 443d operating in application 403d and/or otherwise operatively coupled to application 403d. Additionally or alternatively, selection director component 408b may identify the selected item to one or more operation handler components 443b operating in network application agent 405b, in browser 403b, and/or otherwise operatively coupled to selection director component 408b.

In FIG. 4d, selection director component 408d, as described above, may receive information identifying the selected item from browser 403b and/or network application agent 405b. In an aspect, selection director component 408d receives the selection information from selection handler component 406b. Selection director component 408d identifies the selected item to one or more operation handler components 443d operating in network application 403d and/or otherwise operatively coupled to network application 403d.

An operation handler component may be identified by a selection director component based on selection information received, a selected item, a state and/or setting of an including application; and/or the operation handler may be identified in machine code and/or data of a component in an adaptation and/or analog of the arrangement illustrated in FIG. 3. The machine code may be generated from source code written in a programming language.

The method illustrated in FIG. 2 may include additional aspects supported by various adaptations and/or analogs of the arrangement of components in FIG. 3. For example, in various aspects a selection control may include one or more of a window, a dialog box, a textbox, a check box, a radio button, a slider, a list box, a drop-down list, a spinner, a menu, a menu item, a toolbar, a ribbon, a combo box, a tree view, a grid view, a navigation tab, a scrollbar, a label, a tooltip, a balloon, and a dialog box.

Presenting a first portion of a plurality of items for selection, and subsequently presenting a second portion automatically may include presenting, prior to presenting the first portion, a previous portion, including an item not in the first portion of the plurality, in the selection control. A start scroll indicator may be received, as described above, in response to a user input detected by an input device. In response to receiving the start scroll indicator, the first portion including an item not included in the previous portion may be presented.

A start scroll indicator may be received and/or otherwise detected in response to one or more of presenting the selection control, presenting the previous portion, a user input detected by an input device, presenting a particular item in the previous portion, detecting a timer expiration, detecting a particular time, detecting that a scroll condition is met based on a count of selectable items in the selection control, detecting a change in a resource represented by a selectable item in the plurality, detecting a change in state of a visual component including the selection control, and a detecting message from another application. For example, a scroll condition may be based on a count of items visible in a selection control and/or may be based on a count of items not visible in a selection control. An item resource component 404 may be configured to determine whether and when a scroll condition is met and provide item information to a corresponding item handler component 402 to present another portion of items in a plurality when the scroll condition is met. In another aspect, an item resource component 404 may detect and/or otherwise identify a change in an item. For example, an item not yet presented in a selection control may change state from not selectable to selectable. In response to detecting the change, the item resource component 404 may provide item information identifying the item for presenting in the selection control by an item handler component 402. In still another aspect, a selection control may automatically scroll when the selection control and/or a user interface element including the selection control has input focus for an input device for selecting one or more items. Automatic scrolling may be activated based on a change in input focus, z-order, and/or other attribute of a selection control.

An item may represent a resource that is identified to an operation handler for processing in response to selection of the item. The resource may include a representation of an instruction generated from source code written in a programming language. For example, a resource may include a script instruction, byte code, object code, and/or machine code. Alternatively or additionally, a resource may include data for processing by an instruction-processing unit configured with an instruction including an operand at least one of including the data and referencing the data.

A second portion of a plurality of items may be presented automatically subsequent to the presentation of a first portion of the plurality in response to one or more of presenting the selection control, presenting the first portion, detecting a timer expiration, detecting a particular time, detecting that a scroll condition is met based on a count of items in the selection control, detecting a change in a resource represented by an item in the plurality, detecting a change in state of an application presenting the selection control, and a detecting message from another application.

A detected particular time may be included in a specified time period. The time may identify a start of the time period, an end of the time period, or a time between the start and the end. The time period may have a duration identified based on at least one of a configured value of time, a duration generator for dynamically calculating the duration, a parameter for providing to a duration generator, and a specified time for presenting the second portion.

As described above, a second portion of a plurality of items may be presented automatically subsequent to the presentation of a first portion of the plurality where the second portion includes at least one item not included in the first portion. A number of items included in the second portion that are not included in the first portion may be based on one or more of a preconfigured value, a user-specified value, a type of an item in at least one of the first portion and the second portion, a size of an item presented in the selection control in at least one of the first portion and the second portion, and a visibly detectable attribute of an item presented in the selection control in at least one of the first portion and the second portion. The number may be one or greater than one. Automatic scrolling may provide an appearance of smooth scrolling or not.

Selection information may be received in response to user input detected by any suitable input device. Exemplary input devices include a pointing device, a touch-sensitive device, a voice-sensitive device, and gaze-sensitive device.

First selection information may be received while a first portion of a plurality of items is visible in a selection control or may be received while a second portion of the plurality is visible in the selection control. Second selection information may be received identifying a second item while the first portion is visible or while the second portion is visible. Thus, in an aspect, first selection information and second selection information may be received while the first portion is visible. In another aspect, first selection information and second selection information may be received while the second portion is visible. In still another aspect, one of first selection information and second selection information may be received while the first portion is visible in the selection control and the other one of the first selection information and the second selection information may be received while the second portion is visible.

A third portion of a plurality of items may be automatically presented in a selection control after a second portion has been automatically presented subsequent to a presenting of a first portion of the plurality in the selection control. The third portion includes an item not included in the second portion. The third portion may be presented after at least one of first selection information and second selection information has been received. The third portion may be presented after at least one operation handler has been invoked to perform an operation based on at least one of a first selected item and a second selected item. The third portion may include some or all of the items in the first portion. That is, the scrolling may reverse direction and/or loop from an end of the items in the plurality to the beginning to continue scrolling in the same direction.

Selection information may identify an operation handler. For example, an item may have a content type. An operation handler may be configured for the item based on its content type. In an aspect, a selection director component may identify an operation handler based on a content type of a selected item. In another aspect, an operation handler for an item may be invoked in response to receiving selection information identifying the item. In another aspect, an operation handler may be invoked in response to an operate indicator that is received in response to a detected user input and that is not included in selection information identifying an item to be identified to the operation handler. An operate indicator may be received before, during, and, and/or after receiving selection information identifying an item to be identified to an operation handler to invoke in response to receiving the operate indicator. In an aspect, an operate indicator may identify an operation handler. For example, an operate indicator may be received in response to a detected user input corresponding to an operation item presenting in operation bar 606 in FIG. 6.

As described above, the method illustrated in FIG. 2 may include receiving second selection information identifying a second selected item included in at least one of the first portion and the second portion. The second selection information may be received at least one of before, after, and during receiving of the first selection information. Identifying the first selected item to the first operation handler may include identifying the second selected item to the first operation handler. In another aspect, the first selected item and the second selected item may be identified to the first operation handler in response to the receiving of a first operate indicator, detected in response to a user input.

In yet another aspect, the second selected item may be identified to a second operation handler configured to perform an operation based on the second selected item. Further, the second selected item may be automatically identified to the second operation handler in response to the receiving of the second selection information.

A first selected item may be identified to a first operation handler and a second selected item may be identified to a second operation handler in response to a receiving of an operate indicator, detected in response to a user input.

A portion of a plurality of items presented in a selection control may be determined to be a last portion in a particular direction of scrolling according to an order on the items in the plurality. In response to the determination that the portion is a last portion, a next portion may be automatically presented where the next portion includes an item previously presented and not included in the last portion. The next portion may be identified by reversing direction according to the order of the items or wrapping around to include the first item in the plurality according to the order. In another aspect, in response to the determination that the portion is the last portion including a last item according to the order of the items, scrolling may be stopped or paused to wait for a start scroll indicator before presenting of a next portion.

To the accomplishment of the foregoing and related ends, the descriptions herein and the referenced figures set forth certain illustrative aspects and/or implementations of the subject matter described. These are indicative of but a few of the various ways the subject matter may be employed. The other aspects, advantages, and novel features of the subject matter will become apparent from the detailed description included herein when considered in conjunction with the referenced figures.

It should be understood that the various components illustrated in the various block diagrams represent logical components that are configured to perform the functionality described herein and may be implemented in software, hardware, or a combination of the two. Moreover, some or all of these logical components may be combined, some may be omitted altogether, and additional components may be added while still achieving the functionality described herein. Thus, the subject matter described herein may be embodied in many different variations, and all such variations are contemplated to be within the scope of what is claimed.

To facilitate an understanding of the subject matter described above, many aspects are described in terms of sequences of actions that may be performed by elements of a computer system. For example, it will be recognized that the various actions may be performed by specialized circuits or circuitry (e.g., discrete logic gates interconnected to perform a specialized function), by program instructions being executed by one or more instruction-processing units, or by a combination of both. The description herein of any sequence of actions is not intended to imply that the specific order described for performing that sequence must be followed.

Moreover, the methods described herein may be embodied in executable instructions stored in a computer-readable medium for use by or in connection with an instruction-execution machine, system, apparatus, or device, such as a computer-based or processor-containing machine, system, apparatus, or device. As used here, a “computer-readable medium” may include one or more of any suitable media for storing the executable instructions of a computer program in one or more of an electronic, magnetic, optical, electromagnetic, and infrared form, such that the instruction execution machine, system, apparatus, or device may read (or fetch) the instructions from the computer-readable medium and execute the instructions for carrying out the described methods. A non-exhaustive list of conventional exemplary computer-readable media includes a portable computer diskette; a random access memory (RAM); a read only memory (ROM); an erasable programmable read only memory (EPROM or Flash memory); and optical storage devices, including a portable compact disc (CD), a portable digital video disc (DVD), a high definition DVD (HD-DVD™), and a Blu-Ray™ disc; and the like.

Thus, the subject matter described herein may be embodied in many different forms, and all such forms are contemplated to be within the scope of what is claimed. It will be understood that various details may be changed without departing from the scope of the claimed subject matter. Furthermore, the foregoing description is for the purpose of illustration only, and not for the purpose of limitation, as the scope of protection sought is defined by the claims as set forth hereinafter together with any equivalents.

All methods described herein may be performed in any order unless otherwise indicated herein explicitly or by context. The use of the terms “a” and “an” and “the” and similar referents in the context of the foregoing description and in the context of the following claims are to be construed to include the singular and the plural, unless otherwise indicated herein explicitly or clearly contradicted by context. The foregoing description is not to be interpreted as indicating that any non-claimed element is essential to the practice of the subject matter as claimed.

I claim:

1. A method for automatically scrolling items in a selection control, the method comprising:
presenting, in a selection control in a user interface via an output device, a first portion of a plurality of items;
presenting, automatically and subsequent to the presenting of the first portion, a second portion, of the plurality, including an item not included in the first portion;
receiving first selection information, in response to a user input, identifying a first selected item included in at least one of the first portion and the second portion; and
identifying the first selected item to a first operation handler configured to perform an operation based on the first selected item.

2. The method of claim 1 wherein presenting the first portion comprises:
presenting, prior to presenting the first portion, a previous portion, including an item not in the first portion, in the selection control;
receiving a start scroll indicator; and
presenting, in response to receiving the start scroll indicator, the first portion including an item not included in the previous portion.

3. The method of claim 2 wherein the start scroll indicator is received in response to at least one of presenting the selection control, presenting the previous portion, detecting a user input by an input device, presenting a particular item in the previous portion, detecting a timer expiration, detecting a particular time, detecting that a scroll condition is met based on a count of selectable items in the selection control, detecting a change in a resource represented by a selectable item in the plurality, detecting a change in state of an application presenting the selection control, and detecting a message from another application.

4. The method of claim 1 wherein the second portion is automatically presented in response to at least one of presenting the selection control, presenting the first portion, detecting a timer expiration, detecting a particular time, detecting that a scroll condition is met based on a count of items in the selection control, detecting a change in a resource represented by an item in the plurality, detecting a change in state of an application presenting the selection control, and a detecting a message from another application.

5. The method of claim 1 wherein the second portion includes a number of items that are not included in the first portion and the number is based on at least one of a preconfigured value, a user-specified value, a type of an item in at least one of the first portion and the second portion, a size of an item presented in the selection control in at least one of the first portion and the second portion, a size of the selection control, and a visibly detectable attribute of an item presented in the selection control in at least one of the first portion and the second portion.

6. The method of claim 1 wherein the first operation handler is identified based on the first selection information.

7. The method of claim 1 wherein the first selected item is automatically identified to the first operation handler in response to receiving the first selection information.

8. The method of claim 1 wherein the first selected item is identified to the first operation handler in response to receiving an operate indicator, detected in response to a user input, providing an indication to perform the operation.

9. The method of claim 1 wherein the method further includes receiving second selection information identifying a second selected item included in at least one of the first portion and the second portion.

10. The method of claim 9 wherein the second selection information is received at least one of before, after, and during receiving the first selection information.

11. The method of claim 9 wherein identifying the first selected item to the first operation handler includes identifying the second selected item to the first operation handler.

12. The method of claim 11 wherein the first selected item and the second selected item are identified to the first operation handler in response to receiving a first operate indicator, received in response to a detected user input.

13. The method of claim 9 further comprises identifying the second selected item to a second operation handler configured to perform an operation based on the second selected item.

14. The method of claim 13 wherein the second selected item is automatically identified to the second operation handler in response to receiving the second selection information.

15. The method of claim 9 wherein the first selected item is identified to the first operation handler and the second selected item is identified to a second operation handler in response to receiving an operate indicator, received in response to a detected user input.

16. The method of claim 1 further comprising:
determining that the second portion is an last portion including a last item, in the plurality, according to an order of the items in the plurality; and
in response to determining that the second portion is the last portion, automatically presenting a third portion, including an item previously presented and not included in the last portion, of the plurality.

17. The method of claim 1 further comprising:
determining that the second portion is a last portion including a last item, in the plurality, according to an order of the items in the plurality; and
in response to determining the second portion is the last portion, waiting to receive a start scroll indicator before presenting a third portion, of the plurality, including an item not included in the last portion.

18. The method of claim 1 further including automatically presenting a third portion, of the plurality, including a selectable item not included in the second portion subsequent to presenting the second portion and subsequent to identifying the first selected item to the first operation handler.

19. A system for automatically scrolling items in a selection control, the system comprising:
an item handler component, an item resource component, a selection handler component, and a selection director component adapted for operation in an execution environment;
the item handler component configured for presenting, in a selection control in a user interface via an output device, a first portion of a plurality of items;
the item resource component configured for presenting, automatically and subsequent to the presenting of the first portion, a second portion, of the plurality, including an item not included in the first portion;
the selection handler component configured for receiving first selection information, in response to a user input, identifying a first selected item included in at least one of the first portion and the second portion; and
the selection director component configured for identifying the first selected item to a first operation handler configured to perform an operation based on the first selected item.

20. A computer-readable medium embodying a computer program, executable by a machine, for automatically scrolling items in a selection control, the computer program comprising executable instructions for:
presenting, in a selection control in a user interface via an output device, a first portion of a plurality of items;
presenting, automatically and subsequent to the presenting of the first portion, a second portion, of the plurality, including an item not included in the first portion;
receiving first selection information, in response to a user input, identifying a first selected item included in at least one of the first portion and the second portion; and
identifying the first selected item to a first operation handler configured to perform an operation based on the first selected item.
